(19) United States
(12) Patent Application Publication
(10) Pub. No.: US 2011/0232681 A1
(43) Pub. Date: Sep. 29, 2011

(54) Cosmetic Brush Cleaning Solution

(76) Inventor: Rebecca Jane HATFIELD, Orange City, FL (US)

(21) Appl. No.: 13/073,960

(22) Filed: Mar. 28, 2011

Related U.S. Application Data
(60) Provisional application No. 61/317,786, filed on Mar. 26, 2010.

(51) Int. Cl. B08B 7/00; C11D 3/60

(52) U.S. Cl. 134/6; 510/365

(57) ABSTRACT

A cosmetic makeup brush cleaning solution that effectively cleans, sanitizes, and conditions the bristles of the brush. The ingredients provided in the solution of the present invention do not damage the bristles regardless of bristle material. The cleaning solution also provides the bristles with a pleasant fragrance for when the user is using the cosmetic brush.

The current application claims a priority to the U.S. Provisional Patent application Ser. No. 61/317,786 filed on Mar. 26, 2010.

### FIELD OF THE INVENTION

The invention relates generally to liquid solution that is able to effectively clean and disinfect cosmetic brushes. It is the objective of the present invention to clean and disinfect a cosmetic brush and give it a pleasant smell without damaging the bristles.

### BACKGROUND OF THE INVENTION

Traditional cosmetic brush cleaning solutions available today only serve to release dirt and grime from the cosmetic brushes. In many cases, the traditional cosmetic brush cleaning solutions fail to completely remove all the dirt and grime. In addition, the traditional cosmetic brush cleaning solutions have several major flaws. Many of the existing solutions do not disinfect the brushes and also are damaging to the bristles of the brush. This is caused by not providing adequate conditioning to the brush bristles. In addition to the rough damaged bristles resulting from the use of such solutions, the cosmetic brushes still retain germs and bacteria. Using such brushes will often lead to the skin irritation of the users. To compensate for this, alcohol was introduced to these solutions to disinfect the brush. Though alcohol is able to disinfect, it is still very damaging to the bristles of the brush. The damaged bristles will still lead to the skin irritation of some users. The present invention overcomes such problems by introducing a solution that uses natural and organic ingredients to cleanse, disinfect and condition a cosmetic brush. In addition, the scent of the cleanser has a pleasant calming scent instead of a harsh chemical smell.

### DETAIL DESCRIPTIONS OF THE INVENTION

All illustrations of the drawings are for the purpose of describing selected versions of the present invention and are not intended to limit the scope of the present invention. The present invention is a cosmetic brush cleaning solution for makeup artists.

The solution cleans, sanitizes and conditions the makeup brush(s) so they are ready for immediate re-use. Components are liquids that clean, sanitize (with anti-bacterial agents), and are natural and organic components. The solution comprises of an emollient, an oil remover, a disinfecting agent, a cleaning agent, and a fragrance. The ingredients are mixed into a spray bottle in predetermined amounts. Before each use it is important to ensure the solution is well mixed for a consistent homogenous mixture. In addition to the present invention's cleaning properties, the solution also dries immediately and gives the brush a pleasant fragrance.

The cleaning agent of the solution is able to remove dirt, oil and other particles from the bristles of a make-up brush. In the preferred embodiment of the present invention, the cleaning agent is a clear shampoo. It is preferred that the shampoo be made from a larger percentage of organic content. The organic content, unlike synthetic content with chemicals, are able to preserve the natural state of the bristles. The oil remover of the solution is able to remove oil from the bristles of the cosmetic brush and expedite drying. In the preferred embodiment of the present invention, the oil remover is witch hazel. The disinfecting agent of the solution is able to neutralize and remove the bacteria or other contaminants that have remained on the brush. In the preferred embodiment of the present invention, the disinfecting agent is triclosan. Triclosan is an antibacterial and anti fungal agent that reduces bacterial contamination. The triclosan ensures that the users of the cosmetic brush do not contaminate their skin with the brush. The fragrance of the solution provides a pleasant smell for the user while using the cosmetic brush. In the preferred embodiment of the present invention, the fragrance is rose oil. Due to the brush being exposed to a number of different compounds after use, the brush may slowly gather the dirt and germs that may give the brush a unpleasant scent. While the solution cleans and disinfects the brush, the fragrance will provide the brush with a fresh and more pleasant smell.

In the preferred embodiment of the present invention, the solution is comprised of the following amounts of each contributing compound by volume:

0.1-0.2% fragrance

0.1-0.2% disinfecting agent

2-3% cleaning agent

72-75% oil remover

22-25% emollient

In other embodiments of the present invention, the solution can comprise of different amounts of each contributing compound by volume:

0.1-1% fragrance

0.1-1% disinfecting agent

2% cleaning agent

70-75% oil remover

20-25% emollient

The cosmetic brush cleaning solution can comprise of different amounts of each compound to further enhance the specific compounds effectiveness. For example, if the user wants a strong disinfecting solution, more disinfecting agent can be included in the solution. If the user wishes to have a stronger fragrance to their brush, more of the fragrance can be added to the solution. The cosmetic brush cleaning solution is stored inside a spray bottle for easy application.

To make 8 fluid ounces of the present invention, the user can mix a solution of 2 oz. of rose water, 6 oz. of witch hazel, 1 teaspoon of clear shampoo, 1/16 teaspoon of triclosan, and 8 drops of certified rose oil from an eye dropper. To combine the triclosan with the rest of the solution, ½ oz of the witch hazel is first withheld before mixing and combined with the triclosan beforehand. The triclosan is mixed with the witch hazel until a semi-liquid consistency is achieved. The semi-liquid solution with the triclosan is then mixed in with the rest of the solution. Before use, the cleaning solution is shaken to ensure a homogenous mixture.

The present invention is used differently depending on the type of cosmetic brush being cleaned. The bristles of a cosmetic brush can be made from natural hairs or synthetic bristles. The bristles that are made from natural hairs can be made from fox hairs, pony hairs, sable hairs, raccoon hairs, or any other suitable hairs that can be made into cosmetic brush bristles. To clean the bristles of the cosmetic brush the user is provided with a first tissue and second tissue.

When the bristles of the cosmetic brush are made from natural hairs, the user will first spray the cleaning solution onto the first tissue several times. Once the first tissue is dampened by the cleaning solution, the user is able to clean the bristles by brushing the bristles on the first tissue in a back and forth motion. Once the bristles are cleaned and dampened by the first tissue, the user will brush the bristles of the cosmetic brush on the second tissue several times in a back and forth motion to ensure dryness.

When the bristles of the cosmetic brush are made from synthetic material, the user will hold the first tissue directly under the cosmetic brush and spray the cleaning solution directly onto the bristles. Once the bristles have been dampened by the cleaning solution, the user will brush the bristles on the first tissue in a back and forth motion several times to clean the bristles. Once the user has finished cleaning the bristles, the brush is placed between the second tissue or folded in half and pressed dry. The second tissue will absorb the excess cleaning solution quickly.

Although the invention has been explained in relation to its preferred embodiment, it is to be understood that many other possible modifications and variations can be made without departing from the spirit and scope of the invention as hereinafter claimed.

What is claimed is:

1. A cosmetic brush cleaning solution comprises,
a emollient;
a oil remover;
a disinfecting agent;
a cleaning agent;
a fragrance; and
the solution comprises 0.1-0.2% of the fragrance, 0.1-0.2% of the disinfecting agent, 2-3% of the cleaning agent, 72-75% of the oil remover, and 22-25% emollient.

2. The cosmetic brush cleaning solution as claimed in claim 1 comprises,
wherein the emollient is rose water;
wherein the oil remover is witch hazel;
wherein the disinfecting agent is triclosan;
wherein the cleaning agent is clear shampoo; and
wherein the fragrance is rose oil.

3. A method of using the solution to clean a cosmetic brush comprises,
providing a cosmetic brush having bristles;
providing a first tissue and a second tissue;
providing a spray bottle, wherein the cleaning solution is stored in; and
shaking of the spray bottle to ensure homogenous mixture of the cleaning solution.

4. The method of using the solution to clean a cosmetic brush as claimed in claim 3 comprises,
wherein the bristles are natural hairs selected from the group consisting of fox hairs, pony hairs, sable hairs, and raccoon hairs.

5. The method of using the solution to clean a cosmetic brush as claimed in claim 4 comprises,
spraying the cleaning solution onto the first tissue;
brushing the bristles with a back and forth motion on the first tissue; and
brushing the bristles with a back and forth motion on the second tissue to dry the bristles.

6. The method of using the solution to clean a cosmetic brush as claimed in claim 3 comprises,
wherein the bristles are synthetic bristles.

7. The method of using the solution to clean a cosmetic brush as claimed in claim 6 comprises,
holding the first tissue under the bristles;
spraying the cleaning solution directly on the bristles;
wiping the bristles in a back and forth motion directly on the first tissue; and
folding the second tissue with the cosmetic brush placed flat in between and pressing bristles between fingers to aid in drying.

8. A cosmetic brush cleaning solution comprises,
a emollient;
a oil remover;
a disinfecting agent;
a cleaning agent;
a fragrance;
the solution comprises 0.1-1% of the fragrance, 0.1-1% of the disinfecting agent, 2% of the cleaning agent, 70-75% of the oil remover, and 20-25% emollient;
wherein the emollient is rose water;
wherein the oil remover is witch hazel;
wherein the disinfecting agent is triclosan;
wherein the cleaning agent is clear shampoo; and
wherein the fragrance is rose oil.
